(19) United States
(12) Patent Application Publication
(10) Pub. No.: US 2010/0203869 A1
(43) Pub. Date: Aug. 12, 2010

(54) MOBILE TERMINAL AND METHOD FOR PHONE NUMBER MANAGEMENT USING IMAGE IN MOBILE TERMINAL

(75) Inventor: Ho Min JEON, Goyang-si (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/607,186

(22) Filed: Oct. 28, 2009

(30) Foreign Application Priority Data
Feb. 9, 2009 (KR) 10-2009-0010204

(51) Int. Cl. H04M 3/42; G06K 9/00

(52) U.S. Cl. 455/414.1; 382/118

(57) ABSTRACT

A mobile terminal and a method for phone number management using images in a mobile terminal permit the management of plural phone numbers with a single image through image segmentation. The mobile terminal segments an image into two or more segments and receives and saves phone number management information corresponding to one or more segments. If a call request is input and a segment corresponding to a called party is selected, a call is originated by using the phone number corresponding to the selected segment. While the call is ongoing, the selected segment may be emphasized by being enlarged on the image or brightened relative to other segments.

### CROSS-REFERENCE TO RELATED APPLICATION

This application claims priority from and the benefit of Korean Patent Application No. 10-2009-0010204, filed on Feb. 9, 2009, which is hereby incorporated by reference for all purposes as if fully set forth herein.

### BACKGROUND OF THE INVENTION

1. Field of the Invention

This disclosure relates to a mobile terminal and a method for phone number management using images in a mobile terminal, and more particularly, to a mobile terminal and a method for phone number management using a segmented image with phone numbers associated with at least one of the image segments.

2. Discussion of the Background

Mobile terminals continue to include more convenient functions for differentiation among competing companies.

For example, a mobile terminal provides a function of more rapidly searching for a phone number stored in the terminal using a hotkey to make a phone call.

However, a terminal user has to know the hotkey corresponding to the phone number to be searched for, but this may be difficult to remember since there may be a low correlation between the speed dial number and the corresponding phone number.

Further, a phone number can correspond to an image by using images stored in a mobile phone. Thereafter, a call may be made to a person by selecting the image of that person. The call is then originated by using the phone number corresponding to the image and pressing the “SEND” button.

However, in the existing method, if several phone numbers are registered for a single image (for example, if the image includes several people), then it may be difficult for the user to identify the phone number that corresponds to the desired person to be called.

### SUMMARY OF THE INVENTION

Exemplary embodiments of the present invention provide a mobile terminal and a method for phone number management using images in a mobile terminal, where an image includes segments respectively corresponding to plural phone numbers.

Exemplary embodiments of the present invention also provide a method for originating a call using images in a mobile terminal, where an image segment of a person to be called may be selected from an image by a terminal user, and the mobile terminal performs call originating by using a phone number corresponding to the selected image segment.

Additional features of the invention will be set forth in the description which follows, and in part will be apparent from the description, or may be learned by practice of the invention.

An exemplary embodiment of the present invention discloses a mobile terminal including: a display unit suitable to display an image; an image segmentation unit to segment the image into segments comprising a first segment and a second segment; and a memory to receive first phone number management information corresponding to the first segment, and to match and save the first phone number management information with the first segment, and to receive second phone number management information corresponding to the second segment, and to match and save the second phone number management information with the second segment.

An exemplary embodiment of the present invention discloses a method for phone number management using images in a mobile terminal, including: displaying an image; segmenting the image into segments comprising a first segment and a second segment; receiving first phone number management information and second phone number management information respectively corresponding to the first segment and the second segment; and matching and saving the first phone number management information with the first segment, and matching and saving the second phone number management information with the second segment.

An exemplary embodiment of the present invention discloses a method for originating a call using images in a mobile terminal. The method includes displaying an image comprising a first segment and a second segment, the first segment corresponding to first phone number management information and the second segment corresponding to second phone number management information, selecting the image in an image originating mode of performing call originating using images, selecting the first segment, and performing call originating using a phone number corresponding to the first segment in response to a call request.

An exemplary embodiment of the present invention discloses a method for originating a call using images in a mobile terminal. The method includes displaying an image comprising a first segment and a second segment, the first segment corresponding to first phone number management information and the second segment corresponding to second phone number management information; receiving a multiple phone call request while the mobile terminal is connected with a first counterpart; receiving a selection for a second counterpart corresponding to the second segment; and performing call originating using a phone number corresponding to the second segment in response to a call request.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram schematically illustrating the configuration of a mobile terminal according to an exemplary embodiment of the present invention.

FIG. 2 is a flowchart for describing a method for phone number management using images in a mobile terminal according to an exemplary embodiment of the present invention.

FIG. 3 is a diagram illustrating a segmented image of three people according to an exemplary embodiment of the present invention.

FIG. 4 is a flowchart for describing a method for originating a call using images in a mobile terminal according to an exemplary embodiment of the present invention.

FIG. 5 is a flowchart for describing a method for originating a call using images in a mobile terminal according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

A mobile terminal and a method for phone number management using images in a mobile terminal according to exemplary embodiments will be described in detail with reference to accompanying drawings.

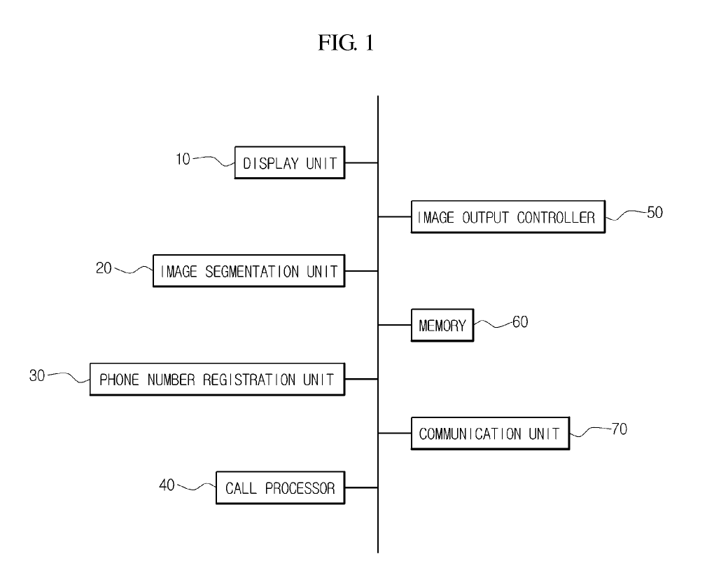

FIG. 1 is a diagram schematically illustrating the configuration of a mobile terminal according to an exemplary embodiment of the present invention.

In FIG. 1, a display unit 10 displays various data, for example, the state of the mobile terminal, information provided by the mobile terminal, a text message transmitted through a mobile communication network, and texts and numerals inputted through an input unit (not shown). In addition, the display unit 10 displays an image captured by a camera unit (not shown) of the mobile terminal or selected from images saved in a memory 60.

An image segmentation unit 20 segments an image into two or more segments. For example, the image segmentation unit 20 may segment an image displaying two or more people into corresponding segments, each of which may include the face of one person in the image. The image segmentation unit 20 described above may automatically segment the image of two or more people displayed on the display unit 10 according to the number of the people using face recognition, or it may segment the image according to a user input.

For example, if the display unit 10 is implemented as a touch screen, the image segmentation unit 20 may segment the image into segments designated by the terminal user using the touch screen. Each segment segmented by the image segmentation unit 20 may have a unique index value. In this instance, the term “unique” may be relative to other segments of the image or other segments of images stored in the memory 60, or may be relative to segments of images stored on other mobile phones as well.

A phone number registration unit 30 receives phone number management information (for example, name, phone number, e-mail addresses, and the like) corresponding to one or more of the segments segmented by the image segmentation unit 20, and configures and saves the information with image-associated information in the memory 60. That is, the image selected by the terminal user, segment information on the selected image, and the phone number management information corresponding to each segment are configured and saved in the memory 60. The single image selected by the terminal user, segment information on the selected image, and the phone number management information corresponding to each segment may be saved in the memory 60 as a single file.

Then, if a call request is input (for example, if the terminal user inputs a call request by pushing a send button or the like) after the user selects a segment of the image displayed on the display unit 10 in an image originating mode, and the selected segment corresponds to a phone number, a call processor 40 performs call originating by using the phone number corresponding to the selected segment.

Here, if the terminal user selects the image segment corresponding to the person to be called from the image displayed on the display unit 10, the terminal user may also input the unique index value of the segment, or select a person to be called by touching the corresponding segment if the display unit 10 is implemented as a touch screen.

Similarly, the terminal user could select a segment corresponding to a person to receive an e-mail message, text message, multimedia message, or similar type of electronic communication.

If an image having segments is displayed on the display unit 10 in the image originating mode, an image output controller 50 displays the segments on the image displayed on the display unit 10. Then, if the call processor 40 attempts to originate a call by using the phone number corresponding to the segment selected in image originating mode, the image output controller 50 emphasizes the segment selected by the terminal user to show a counterpart. Here, emphasizing the segment may include one or more of enlarging the selected segment, making the selected segment brighter, making the other segments darker, or the like.

In addition, if a call is incoming and an image corresponding to an originating phone number of the incoming call is searched for and retrieved from the memory 60, the image output controller 50 may display the retrieved image on the display unit 10. If the retrieved image is an image having segments, the segment corresponding to the originating phone number may be emphasized in a manner similar to that described above by the image output controller 50.

In addition, the image output controller 50 may emphasize the segment of a caller corresponding to the line on which a current voice signal is received during multiple phone calls.

The memory 60 stores various programs for the operation and control of the terminal and programs for implementing a method for phone number management using images according to this disclosure. In this memory 60, personal information (for example, phone number, personal schedule, celebration days, memos, and the like) and various data input by the terminal user, and images acquired by a camera unit (not shown) or transmitted through the mobile communication network or a local area network may be stored.

If the terminal user inputs a call request to send the image having segments to another mobile terminal (not shown), a communication unit 70 transmits a file to the other mobile terminal (not shown) designated by the terminal user through the mobile communication network or the local area network. The file may be configured with the image selected by the terminal user, the segment information on the selected image, and the phone number management information corresponding to each segment. The file could be transmitted as a single file or multiple files.

For convenience of description, the case where two or more segments are generated by segmenting an image of two or more people has been described as an example. However, the embodiment is not limited thereto, because the image used in the mobile terminal may not only be an image of two or more people. For example, the mobile terminal may extract a segment of a person from the image to match phone number management information on the person shown in the segment. Then, the mobile terminal may segment two or more objects remaining in the image, for example, a person and a building, into segments according to the objects. For example, the next two segments may include a person part and a building part, respectively. Then, the mobile terminal may register phone number management information, such as a phone number of the person and a phone number of an office or business in the building, to the segments.

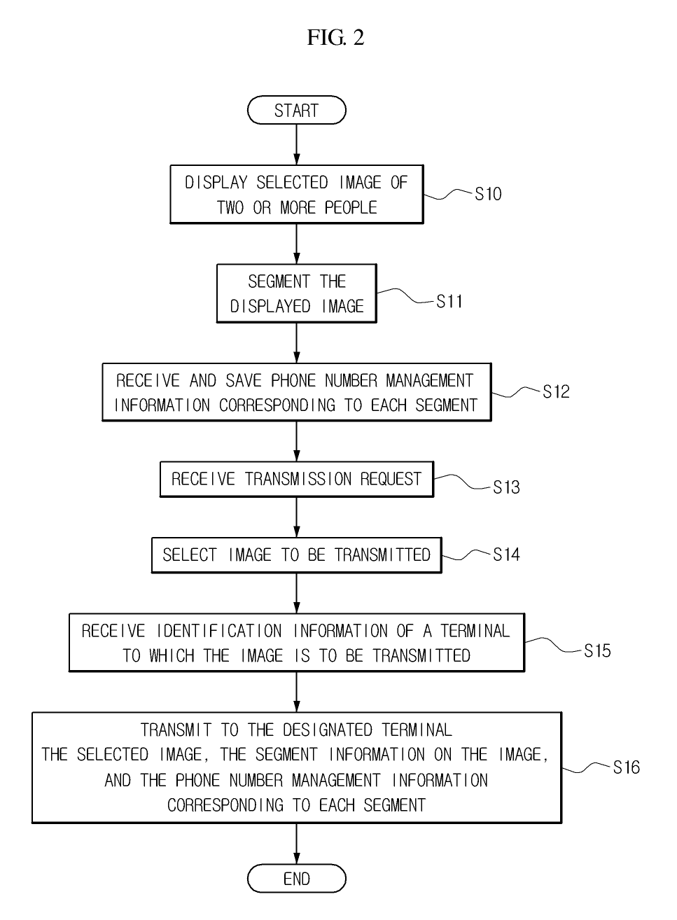

FIG. 2 is a flowchart for describing a method for phone number management using images in a mobile terminal according to an exemplary embodiment of the present invention.

If the terminal user selects an image from the images saved in the memory 60, the display unit 10 of the mobile terminal displays the selected image (S10).

Then, the image segmentation unit 20 segments the image displayed on the display unit 10 into two or more segments, automatically or according to a request of the terminal user (S11).

In S11, the image segmentation unit 20 may automatically segment the image according to the number of people included in the image through face recognition, or if the display unit 10 is implemented as a touch screen, may segment the image into segments designated by the terminal user using touch screen.

Each segment segmented in S11 may have a unique index value.

After the image is segmented into two or more segments in S11, the phone number registration unit 30 receives the phone number management information (for example, name, phone number, e-mail address, and the like) corresponding to one or more of the segments, and configures and saves the information with the image-associated information in the memory 60 (S12). In this instance, the information with the image-associated information may be the image selected in S10 with the segment information on the selected image. Further, as explained above, this could be stored as a single file in the memory 60.

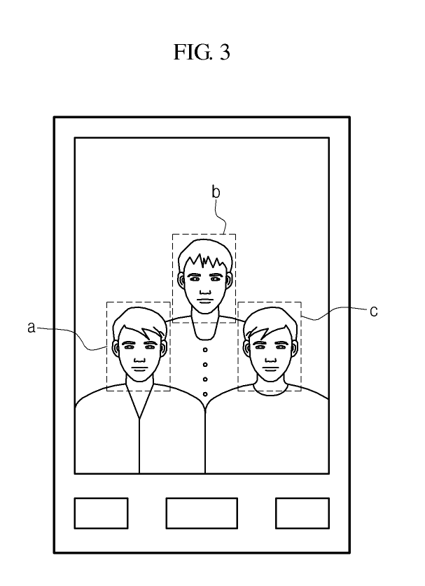

FIG. 3 is a diagram illustrating a segmented image of three people according to an exemplary embodiment of the present invention. As explained in the preceding paragraph, an image of three people may be segmented into three segments a, b, and c as shown in FIG. 3. Then, the phone number registration unit 30 receives the phone number management information (for example, name, phone number, e-mail address, and the like) corresponding to each segment a, b, and c.

In S12, the phone number registration unit 30 may newly receive and save the phone number management information corresponding to one or more of the segments in the memory 60 by the terminal user, or may save in memory 60 a phone number stored in the memory 60 in advance to be matched with the corresponding image segment.

The terminal user may input a transmission request to the mobile terminal to transmit the image having segments to another mobile terminal (S13), select an image having segments to be transmitted to the mobile terminal (S14), and input identification information of the receiving mobile terminal to which the image having segments is to be transmitted (S15). In this case, the communication unit 70 transmits a single file configured with the image selected by the terminal user, the segment information on the selected image, and the phone number management information corresponding to each segment to the mobile terminal designated by the terminal user through the mobile communication network or the local area network (S16).

The receiving mobile terminal receiving the image in S16 may view and/or save the received image in a memory and use it for call originating using images.

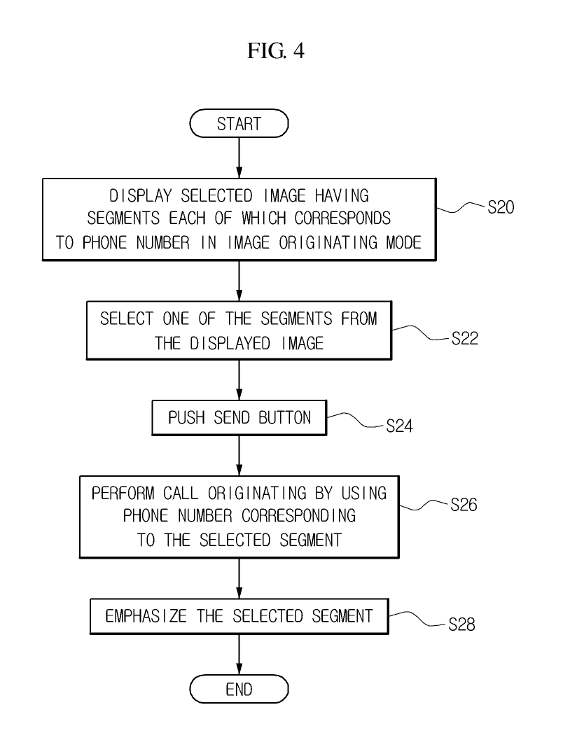

FIG. 4 is a flowchart for describing a method for originating a call using images in a mobile terminal according to an exemplary embodiment of the present invention.

If the image having segments is selected by the terminal user in the image originating mode of performing call originating using images, the mobile terminal displays the selected image on the display unit 10 along with the segments on the selected image as illustrated is in FIG. 3 (S20).

Then, the segment (for example, segment c on FIG. 3) corresponding to a person to be called is selected from among the segments of the image displayed on the mobile terminal (S22). Thereafter, if a call request is input (S24), the call processor 40 performs call originating by using a phone number or other contact information corresponding to the selected segment (S26).

Then, while the call processor 40 attempts to originate a call to the phone number corresponding to the selected segment, the image output controller 50 emphasizes the selected segment by, for example, enlarging the selected segment, making the selected segment brighter, and/or making the other segments darker to emphasize the counterpart shown in the selected segment (S28).

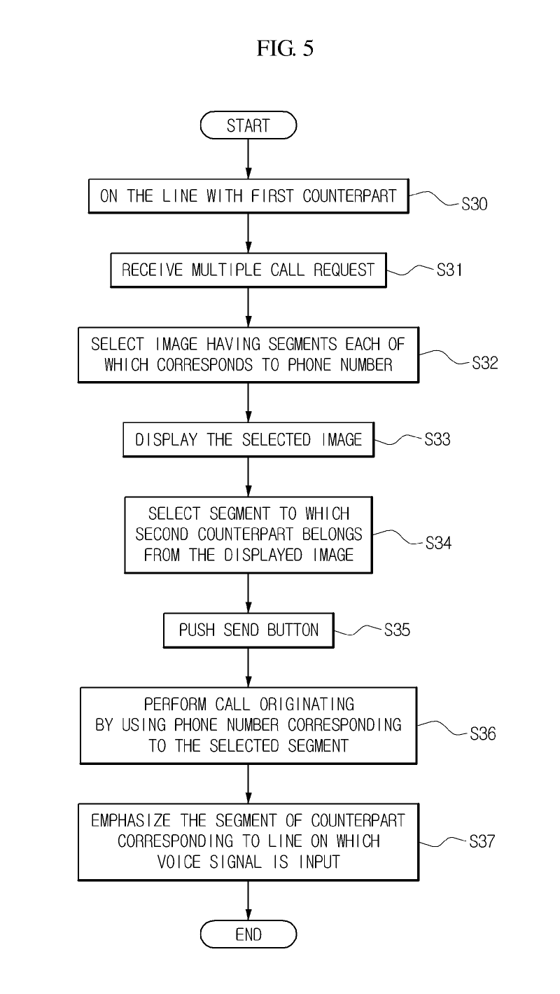

FIG. 5 is a flowchart for describing a method for originating a call using images in a mobile terminal according to an exemplary embodiment of the present invention.

If a multiple phone call request is input from a terminal user (S31) while a mobile terminal is connected with a first counterpart (S30), and an image having segments is selected (S32), the selected image is displayed on the display unit 10 along with the segments on the selected image as illustrated in FIG. 3 (S33).

Then, the segment corresponding to a second counterpart to be called is selected from the segments of the image displayed on the mobile terminal in S33 (S34). Thereafter, if a call request is input (S35), the call processor 40 performs call originating by using a phone number corresponding to the segment selected in S34 (S36).

While the multiple calls are connected through the aforementioned operations, and when a voice signal is input through a line, the mobile terminal enlarges the segment of a counterpart corresponding to the line on which the current voice signal is input, makes the selected segment brighter, and/or makes the other segments darker to emphasize the counterpart on the line (S37).

The mobile terminal and the method for phone number management using images in a mobile terminal are not limited to the embodiments described above but may be modified in various manners without departing from the spirit and scope of the invention.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed, but that this disclosure will include all embodiments falling within the scope of the appended claims and their equivalents.

What is claimed is:

1. A mobile terminal, comprising:
a display unit to display an image;
an image segmentation unit to segment the image into segments comprising a first segment and a second segment; and
a memory to receive first phone number management information corresponding to the first segment, and to match and save the first phone number management information with the first segment, and to receive second phone number management information corresponding to the second segment, and to match and save the second phone number management information with the second segment.

2. The mobile terminal according to claim 1, further comprising:
a call processor to perform call originating by using the first phone number management information corresponding to the first segment in response to a call request.

3. The mobile terminal according to claim 1, wherein the image segmentation unit automatically segments the image into segments according to a number of people included in the image using face recognition.

4. The mobile terminal according to claim 1, wherein the image segmentation unit segments the image into segments designated by a terminal user through the display unit implemented as a touch screen.

5. The mobile terminal according to claim 1, wherein each segment segmented by the image segmentation unit has a unique index value on the image.

6. The mobile terminal according to claim 2, further comprising:
an image output controller to emphasize the first segment while call originating is performed by the call processor.

7. The mobile terminal according to claim 6, wherein the image output controller emphasizes the first segment by enlarging or brightening the first segment.

8. The mobile terminal according to claim 1, further comprising:
a communication unit to transmit the image, segment information on the image, the first phone number management information, and the second phone number management information to a receiving mobile terminal through a communication network in response to a transmission request.

9. The mobile terminal according to claim 8, wherein the image, the segment information on the image, the first phone number management information, and the second phone number management information are transmitted by the communication unit as a single file.

10. A method for phone number management using images in a mobile terminal, comprising:
displaying an image;
segmenting the image into segments comprising a first segment and a second segment;
receiving first phone number management information and second phone number management information respectively corresponding to the first segment and the second segment; and
matching and saving the first phone number management information with the first segment, and matching and saving the second phone number management information with the second segment.

11. The phone number management method according to claim 10, further comprising:
receiving a transmission request for the image;
receiving identification information of a receiving mobile terminal; and
transmitting the image, segment information on the image, the first phone number management information, and the second phone number management information to the receiving mobile terminal through a mobile communication network.

12. The mobile terminal according to claim 11, wherein the image, the segment information on the image, the first phone number management information, and the second phone number management information are transmitted as a single file.

13. A method for originating a call using images in a mobile terminal, comprising:
displaying an image comprising a first segment and a second segment, the first segment corresponding to first phone number management information and the second segment corresponding to second phone number management information;
selecting the image in an image originating mode of performing call originating using images;
selecting the first segment; and
performing call originating using a phone number corresponding to the first segment in response to a call request.

14. The call originating method according to claim 13, further comprising:
emphasizing the first segment while a call to the phone number corresponding to the first segment is originated or maintained.

15. A method for originating a call using images in a mobile terminal, comprising:
displaying an image comprising a first segment and a second segment, the first segment corresponding to first phone number management information and the second segment corresponding to second phone number management information;
receiving a multiple phone call request while the mobile terminal is connected with a first counterpart;
receiving a selection for a second counterpart corresponding to the second segment; and
performing call originating using a phone number corresponding to the second segment in response to a call request.

16. The call originating method according to claim 15, further comprising:
emphasizing the second segment when a voice signal is input on a line on which the second counterpart is connected.

17. The call originating method according to claim 13, wherein the first segment and the second segment are displayed on the image if the mobile terminal displays the image.
